(19) United States
(12) Patent Application Publication
(10) Pub. No.: US 2026/0136069 A1
(43) Pub. Date: May 14, 2026

(54) INTELLIGENT VIEWING PHASE IDENTIFICATION AND RECOMMENDATION

(71) Applicant: DISH Network L.L.C., Englewood, CO (US)

(72) Inventors: Abigail Doolen, Castle Pines, CO (US); Levi Boscardin, Denver, CO (US)

(73) Assignee: DISH Network L.L.C., Englewood, CO (US)

(21) Appl. No.: 18/945,964

(22) Filed: Nov. 13, 2024

(51) Int. Cl. H04N 21/466; H04N 21/431

(52) U.S. Cl. CPC H04N 21/4668; H04N 21/4316

(57) ABSTRACT

Systems, devices, and processes receive first metadata descriptive of media programs watched by viewers and second metadata descriptive of the viewers, and can provide the first metadata about the media programs and the second metadata about the viewers to train an artificial intelligence (AI) model on the viewers and the media programs. A viewer device playing a media program may detect a recommendation trigger during a first playback of the media program. The AI model may be applied to third metadata related to the viewer and fourth metadata related to the media program during the first playback to generate a viewing recommendation for the viewer in response to the recommendation trigger. The viewing recommendation can be presented to the viewer during the first playback of the media program on the viewer device.

### TECHNICAL FIELD

The following generally relates to automated generation of viewing recommendations related to television programs, movies or other media program content. Some implementations may make use of artificial intelligence (AI) constructs, as described herein.

### BACKGROUND

Media consumption has undergone a remarkable evolution in recent years, transitioning from a collective family activity centered around the living room television set to a highly personalized experience that can be enjoyed across a multitude of devices and settings. In the bygone era, viewers were bound to programming schedules and limited media distribution, thereby constraining their television and movie watching to specific times and places. Now, with the proliferation of advanced streaming services and portable devices such as smartphones, tablets and laptops, individuals have the freedom to access a diverse range of media content anytime and anywhere.

The shift to on-demand viewing liberates users from the constraints of traditional broadcasting schedules and geographic limitations, offering unprecedented convenience and choice. The modern landscape of media consumption, bolstered by technologies like digital video recorders and streaming media, caters to the individual's preferences and provides a tailored viewing experience. This has made an extensive library of content more accessible than ever, eliminating the barriers of space and time that once limited viewing opportunities.

Viewing habits of individuals are often personal and can vary from individual to individual. For example, while a particular viewer may hold dramatic fantasy shows in the highest regard, the same individual may tend to want something different after a binge-watching session. Current tools fall short of recognizing an individual's potential desire for genre change, time constraints, or other viewing habits detectible in an individual's viewing phase.

### BRIEF DESCRIPTION

Systems, devices, and automated processes described herein can automatically generate viewing recommendations to viewers. An example process can include the steps of receiving first metadata descriptive of media programs watched by viewers and second metadata descriptive of the viewers, and of providing the first metadata about the media programs and the second metadata about the viewers to train an artificial intelligence (AI) model on the viewers and the media programs. A viewer device playing a media program may detect a recommendation trigger during a first playback of the media program. The AI model may be applied to third metadata related to the viewer and fourth metadata related to the media program during the first playback to generate a viewing recommendation for the viewer in response to the recommendation trigger. The viewing recommendation can be presented to the viewer during the first playback of the media program on the viewer device.

In various embodiments, the AI model comprises a large language model (LLM). Applying the AI model may include formulating a natural language query including the third metadata and the fourth metadata. The natural language query may be submitted to the LLM to generate the viewing recommendation. Presenting the viewing recommendation comprises displaying the viewing recommendation as an overlay on the viewer device during a second playback of a credit roll of the media program. An unsuccessful recommendation can be logged in response to the viewer declining a second playback of the viewing recommendation. A second playback of the viewing recommendation can be monitored in response to the viewer accepting the second playback of the viewing recommendation. Applying the AI model may include the steps of applying the AI model to the third metadata and the fourth metadata to generate a list of viewing recommendations for the viewer, the list comprising the viewing recommendation. The viewing recommendation may be selected from the list for presentation to the viewer. Selecting the viewing recommendation from the list further includes ranking the list of the viewing recommendations for the viewer, and selecting the viewing recommendation from the list in response to a ranking of the viewing recommendation on the list.

Another example process can include preparing first metadata describing program content and a second metadata describing viewers of the program content and associated behaviors. The AI model can be trained using the first metadata and the second metadata to make recommendations based on viewer data and content data. The AI model receives third metadata related to a current viewer and fourth metadata related to a current program during playback of the current program. The AI model generates a viewing recommendation for the current viewer in response to the third metadata and the fourth metadata. The viewing recommendation can be returned to the viewer device during the first playback of the media program on the viewer device. The AI model receives a result of the viewing recommendation as feedback to refine the AI model.

In various embodiments, the AI model can be optimized using the feedback to improve a recommendation-acceptance rate. The third metadata includes a typical viewing period of the current viewer, and the AI model generates the viewing recommendation to have a runtime fit in the typical viewing period. The AI model may generate the viewing recommendation with a recommended content that deviates from a preferred genre of the current viewer based on similar past deviations of the current user. The AI model may generate the viewing recommendation with a recommended content that deviates from a preferred genre of the current viewer based on similar past deviations of similar users.

An example non-transitory computer-readable medium can be configured to store instructions thereon that, when executed by a processor, cause the processor to perform operations. The operations may include receiving, by an AI model, first metadata related to a current viewer and second metadata related to a current program during playback of the current program on a viewer device. The AI model may generate a viewing recommendation for the current viewer in response to the first metadata and the second metadata. The viewing recommendation can be returned to the viewer device during the first playback of the media program on the viewer device. The AI model can receive a result of the viewing recommendation as feedback to refine the AI model.

Additional embodiments provide other systems, devices, computing systems and automated processes substantially as described herein, and/or their legal equivalents.

### BRIEF DESCRIPTION OF THE DRAWINGS

FIG. 1 illustrates an example data processing system for automated generation and distribution of viewing recommendations relating to media programs, in accordance with various embodiments.

FIG. 2 illustrates an example of an automated process to automatically generate viewing recommendations related to a viewer and currently viewed content, in accordance with various embodiments.

FIG. 3 illustrates an example of a process to train an AI model for making viewing recommendations related to a viewer and currently viewed content, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, the media viewing experience can be greatly improved by providing automatically-generated viewing recommendations. These automatically-generated recommendations can be provided on a display while the viewer is enjoying a program, approaching the end of a program, browsing for a program, or based on other triggers identified in the historic data of the user and of other similar users. Recommendations can be provided in a “second screen” or other companion device such as a phone, tablet, computer or other web-browsing device, either as the viewer is watching the program or at another time. Automatic recommendations can identify a desire or need in the user's viewing habits that the viewer might not otherwise identify. The recommendation can thus guide the user's viewing towards content that is compatible with current needs or interests.

Viewing recommendations can be generated in any manner. In various embodiments, a locally-executing or remotely-available artificial intelligence (AI) agent can be prompted with a natural language query to generate relevant recommendations. The AI agent may be trained on metadata about media programs, if desired, including actual program content (e.g., timed text, audio and/or video content). Alternatively or additionally, the AI agent may obtain information about the identified program from public or private databases, crowdsourced data and/or any other source. Automatically-generated recommendations can be based on the viewing history of an individual viewer or of larger groups of viewers. By providing relevant and timely recommendations, the automatically-generated content can enhance the enjoyment of the viewing experience.

To that end, various embodiments make use of large language models (LLMs) or similar artificial intelligence constructs. The artificial intelligence capabilities may be executed by a server system associated with a content provider, by a viewer-associated device (e.g., a phone, tablet or computer), or by a network service accessible to the content provider and/or the viewer device. In some implementations, the trained AI will receive a natural language query that is unique to the relevant program (e.g., “What are some viewing recommendations for viewers with traits XYZ that just finished watching program A for three hours?”). The natural language queries may be further enhanced with viewer information (e.g., “Make a viewing recommendation for a teenager who has about 1.5 hours of viewing remaining in a session and is half way through media program A?”), or with details about the program (e.g., “Make a viewing recommendation for a user who just finished viewing three episodes of a sports programs and typically prefers comedy after long sports viewing sessions?”). Other embodiments may generate more sophisticated queries using any number of factors, as described more fully herein.

In some examples, the AI system can be trained on user data as well. AI systems trained on past user history and subsequent viewing habits and selections can predict future viewing habits and selections. The AI system can compare the user's current traits or viewing activities to the user's past history to make recommendations. The AI system can compare the user's current traits or viewing activities to histories of other groups of users that have had similar viewing traits and activities to identify future selections made by those groups of users. The AI system may make viewing recommendations aligning with those other groups of users and accounting for content already viewed by the user receiving the recommendations.

In various embodiments, the AI model can focus on a user changing viewing habits over time. For example, a viewer that just binge watched several episodes of a dramatic program may want something light hearted. The AI model can make viewing recommendations for light-hearted content based on past user behavior preferring light-hearted content after binging dramatic content. In that regard, the AI model can consider time spent in viewing a category or subcategory of content as well as past user changes from the category or subcategory to a different type of content over time.

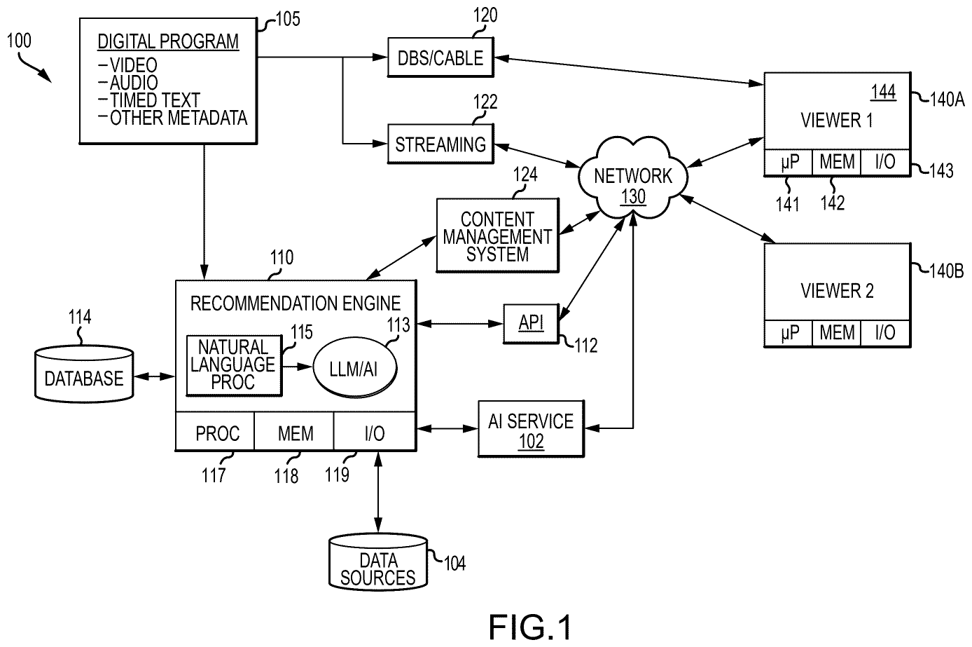

Turning now to the drawing figures and with initial reference to FIG. 1, an example system 100 to automatically generate viewing recommendations may include a recommendation engine 110 that formats natural language queries based upon information about a media program and a user to arrive at machine-generated viewing recommendations. Automatically-generated viewing recommendations may be delivered to any number of media viewer devices 140A-B via a content management system (CMS) 124, via an application program interface (API) 112, or with the content itself as desired.

Viewing recommendations can be generated in any manner, based upon any available information about the particular media program. In various embodiments, a generative AI model 113 (or similar AI construct) executes within the recommendation engine 110 to process queries that result in automatically-generated viewing recommendations. Alternatively, recommendation engine 110 formats natural language queries that can be posited to commercial LLMs, commercial databases, public databases or other data sources 102, 104 via the Internet or another network 130. Formatted queries and any recommendations or responses received from AI 113 can be stored in a database 114 for subsequent retrieval and further processing, if desired.

Digital content 105 may be received and delivered in any manner. Digital content 105 may also be referred to herein as a program, content, media, or other similar related terms. In various embodiments, digital content 105 is received via network 130, via terrestrial or satellite broadcast, or in any other manner. Digital content 105 typically includes a multiplex of digital streams that are synchronized in time to represent a particular television program, movie or other media program. An MPEG multiplex, for example, typically represents a media program with one or more video streams, one or more audio streams, one or more timed text streams and associated metadata that encodes the content of the particular program 105. Generally speaking, the various component streams of the multiplex are synchronized by common timing data, such as a presentation time stamp (PTS), so that content from the various video, audio and timed text streams can be presented in synchrony to the viewer.

In some implementations, system 100 delivers content 105 to the various viewer devices 140A-B for playback. FIG. 1 illustrates a digital broadcast satellite (DBS) or cable connection 120 that provides a broadcast of the content, along with a video streaming system 122 that provides an over the top (OTT), IPTV, or other type of video stream. Although FIG. 1 illustrates both broadcast and streaming media delivery services, various embodiments of system 100 might include both, one, or neither of these distribution schemes. Other embodiments could deliver content 105 via any other broadcast or streaming services, as desired. Further, it is possible to deliver automatically-generated recommendations separate from the content. The generated viewing recommendations could be delivered by system 100 that is separate from the delivery of the underlying content 105, in accordance with various embodiments.

Viewers can enjoy their media program content and receive automatically-generated viewing recommendations in any manner. In the example of FIG. 1, viewers make use of hardware devices 140A-B such as set-top boxes (STBs), smart televisions, video streaming devices, personal computers, mobile phones, tablets or the like. Different viewers may make use of different types of devices 140A-B, each having computing hardware such as a processor 141, memory or other non-transitory digital storage 142 and suitable input-output interfaces 143, as desired. In the example of FIG. 1, the viewer controls his or her device 140A to select and view media programs 105, to receive viewing recommendations from system 100, and to respond to system 100 via API 112 on network 130. Other embodiments could split the media viewing and recommendation-generation processes across two or more devices 140, if desired. A viewer may watch a program 105 on a regular television set, for example, while simultaneously interacting with the automatically-generated viewing recommendations on a tablet, phone or personal computer.

Recommendation generation engine (RGE) 110 may operate in any manner. In the example of FIG. 1, RGE 110 and other computer-based systems described herein may execute using conventional computing hardware such as one or more processors 117, non-transitory digital storage 118, and any appropriate input/output interfaces 119. Equivalent embodiments may make use of cloud-based computing resources such as the virtual machine architectures provided by Amazon Web Services (AWS), Microsoft Azure, Google Cloud, IBM Cloud, or the like.

RGE 110 processes available data and/or interacts with other services to generate the viewing recommendations referenced herein. In one example, RGE 110 supports a large language or other AI model 113 that is trained upon data relating to media programs 105, user viewing histories, use groupings, and other relevant data. The data may include actual program content, such as the audio content or the timed text content, as appropriate. Audio content may be analyzed after performing a speech-to-text conversion, as desired. Similarly, video content may be analyzed using a computer vision tool to analyze visual elements that can add understanding to the context (e.g., scene changes, key actions) if desired. Examples of such tools could include the Open Computer Vision Library (OpenCV), the TensorFlow tools available from Google Inc., or any number of other tools desired.

In many implementations, the timed text stream of program 105 will provide a detailed summary of the program contents, along with convenient timing information from the presentation time stamps or other timing data. The text may be analyzed to recognize characters, scenes, and other attributes of the media program. In addition or as an alternative to content derived from the program itself, AI model 113 may be additionally or alternately trained on additional metadata, or information about the program, that is available from data sources 104, such as any public database (e.g., Wikipedia), private database (e.g., the GRACENOTE media database service available from Gracenote, Inc. of Emeryville, California or the IMDB service maintained by Amazon Inc. of Seattle, Washington), user data, past interaction (e.g., rewind, skip, or pause) data, and/or the like.

In some implementations, metadata, program content and/or any other data used to train the model may be provided to an AI framework that converts the received data to mathematical vectors that can be stored in a database for further processing and retrieval. Vectors may be stored in database 114, if desired, and/or in a separate database that is formatted for use by AI 113. After training, AI 113 may be configured to identify a current viewing phase of individual users. AI 113 can analyze the current viewing phase of an individual user by comparing with the individual user's past viewing history to identify recommendations likely to be well received by the individual user. AI 113 can analyze the current viewing phase of an individual user by comparing with past viewing history of similar users to identify recommendations likely to be well received by the individual user.

Network AI services 102 could also be used to obtain content or to assist in generating viewing recommendations, as desired. Examples of current AI services 102 include, without limitation, the ChatGPT service available from OpenAI, the Bard service available from Google, the MetaAI service available from Meta Inc., the Watson service available from IBM Corp. Additional AI services are being deployed rapidly, and any of these services could be equivalently used, if desired.

In one example, RGE 110 deploys a Large Language Model (LLM) or similar AI model 113 for automatically generating viewing recommendations based on digital content 105, the active user profile, similar user profiles, a viewing history, or other relevant data points. This AI 113 is trained using a dataset that includes data such as the timed text (e.g., subtitles or captions) associated with the digital content 105, as supplemented with data obtained from various data sources 104. Data sources 104 can include web-based, closed loop, private, or third-party data sources. Additional data could include the title of the program, program genre, program characteristics, the names of actors and actresses appearing in the program, professional or amateur reviews or commentary, awards won by the program, and any other information as desired. The inclusion of external web data can enhance the model's comprehension and contextual relevance, making it more effective in understanding and interacting with the content. Further, the use of additional data can be particularly useful when there are gaps in the primary training dataset or when more diverse inputs are required to enhance the model's accuracy and effectiveness. As noted above, any received data can be provided to the LLM to generate sets of vectors that can be stored for use in subsequent analysis, including responses to natural language queries.

The architecture of the AI 113 can be designed to be flexible, and to adapt to one or more existing frameworks if desired. These frameworks provide the foundational structure and learning algorithms for the LLM and may also provide resources for “training” custom models by converting input data to mathematical vectors or the like. Frameworks such as LLAMA from Meta Corporation, ChatGPT from OpenAI, and BARD from Google Inc. could be used, for example, to provide just a few examples of the many different frameworks that could be equivalently used. Custom-built AI frameworks could also be employed that are tailored to specific needs or objectives. Each of these frameworks has its unique strengths and methodologies, making them suitable for different aspects of language processing and learning.

In various embodiments, a natural language processing (NLP) module 115 allows for natural language queries to be placed to the AI 113 to generate the viewing recommendations based upon relevant information. Some prompts may relate to general concepts (e.g., “List some programs from a different genre than program X that are usually enjoyed by viewers of program X?”). In some embodiments, however, viewing recommendations can be generated using prompts including additional reference to particular viewer's attributes (e.g., prompts could be tailored based upon gender, geographic location, age, viewing history, genre preference, time constraints, or any number of other factors). Still further embodiments could generate different recommendations based upon the viewer's playback point in the program, thereby offering viewing recommendations after a long pause or after a viewer has stopped playback at a point where they would typically continue viewing. Again, prompts in an LLM-based example can be tailored as desired so that they are specific to the program, as well as the viewer and the viewing position in the program.

The AI 113 and/or network AI service 102 process recommendation requests in any manner to produce the requested viewing recommendation. In various embodiments, the AI engine provides a framework for parsing the natural language query and for searching the vector space of generated vectors to arrive at suitable results. Other AI engines and implementations could operate in any other manner, using any sort of mathematical, statistical, data processing and/or other features to implement the AI model. Results can be digitally returned in response to the received queries via a network, via an inter-process or bus communication within data processing system RGE 110, and/or in any other manner. In some examples, RGE 110 can receive text-based viewing recommendations and generate links, thumbnails, previews, pages, auto-play triggers, or other interaction points at which the recommended program can begin playback.

Generated viewing recommendations and the like are provided to the viewer devices 140A-B in any manner. In one example, media client applications 144 executed by viewer devices 140A-B communicate with the content management system 124 to provide digital updates about the viewing experience, including content requested, content viewed, viewing habits, viewing duration, and/or the like. Content management system 124 may also be involved with ad replacement or tracking, or other viewer experiences as desired. An example of a content management system that is used to track ad viewing within an adaptive media streaming environment is described in U.S. Pat. No. 11,463,785 (incorporated herein by reference), although other types of content management systems could be used in other embodiments. Such systems could be modified to distribute viewing recommendations and other data, if desired.

In one example, content management system 124 obtains viewing recommendations based on the currently-viewed program and current user profile from RGE 110 and/or database 114. Received viewing recommendations are then forwarded to the viewer devices 140A-B as appropriate. Alternatively, viewer devices 140A-B may communicate with RGE 110 and/or database 114 via API 112 to generate viewing recommendations locally. Viewing recommendations may be digitally presented to the viewer, and can be accepted or automatically triggered. In some embodiments, viewing recommendations can be retrieved, modified, or otherwise interacted with via API 112 for storage in database 114 and/or further processing, as desired.

In various embodiments, viewing recommendations can be presented in a visual interface that includes currently-playing content and viewing recommendations. The presentation can include viewer selectable buttons to trigger playback, queue playback, or add recommended content to a watch list. Various embodiments could alternately present the viewing recommendations, for example, as an overlay on the rendered video imagery. A presentation window could be presented in a window that is side-by-side with rendered imagery, for example. Still other embodiments could provide the automatically-generated viewing recommendations in a completely separate window, if desired. Even further, viewing recommendations could be presented on a separate device such as, for example, a smartphone or tablet. If a viewer is enjoying program content 105 on a television screen, for example, automatically-generated viewing recommendation could be presented via a companion application executing on the viewer's smartphone, tablet or other device. Timing could be coordinated between the two devices by sharing PTS or other playback timing data (e.g., via CMS 124) from the playback of the media program, thereby ensuring that viewing recommendations are not presented to the second device until the relevant playback point in program 105 has been reached (e.g., the credits are rolling). Other embodiments may be formulated to permit convenient media playback and presentation of viewing recommendations, as desired.

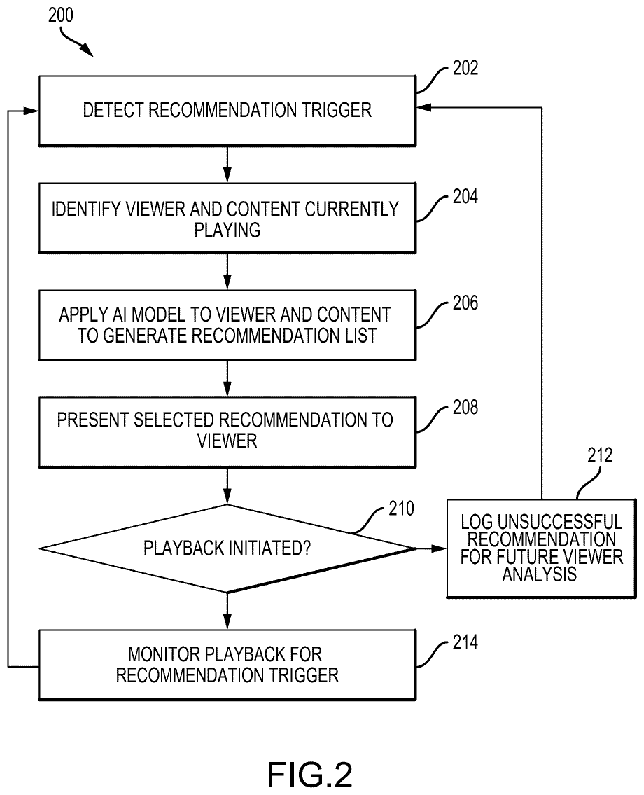

FIG. 2 depicts a flowchart of an example process 200 to manage the automatic generation of viewing recommendations in media viewing system 100, in accordance with various embodiments. The various functions of process 200 may be performed using processor 116 executing software, firmware or other programmable logic, as augmented by the other components of system 100. Other embodiments may divide processing between the various components of system 100, including viewer devices 140A-B, as desired. In some implementations, a media application 144 could contain an AI model or other construct that has been trained on various user data and media programs so that some or all of the recommendation generation could be handled locally on devices 140A-B, thereby reducing processing demands on RGE 110. In this instance, media application 144 could interact with RGE 110 and/or another AI service 102 to supplement the local processing capability, if desired. In a further embodiment, an AI executing locally on viewer device 140A obtains initial viewing recommendations from RGE 110 and/or AI services 102 but generates supplementary viewing recommendations using a locally-executed model. To that end, viewing recommendations generated by AI elements executing on viewer device 140, RGE 110, and networked services 102 could be combined in any manner.

With reference now to FIG. 2, an example of an automated process 200 may include detecting a recommendation trigger in media under current playback (Block 202). In response to the playback trigger, or in advance of the trigger in some embodiments, system 100 then generates a recommendation. System 100 can implement the broad functions of identifying information about currently playing media programs 105 and the viewing user (Block 204). Identification of the viewing user can include looking up metadata associated with the viewing user's account or devices. For example, the user's viewing history and habits can be looked up based on a unique identifier associated with their account. The currently playing media can be identified, for example, by polling or querying viewer device 140A or content management system 124. In embodiments functional on device startup, the currently playing content may be null or may otherwise indicate that the viewer has not initiated playback during the current viewing session.

In various embodiments, system 100 may analyze the user and the currently playing content using the AI model to generate viewing recommendations (Block 206). The user can be identified to the AI model using a unique identifier useable to lookup characteristics of the user in some embodiments. In various embodiments, the user can be identified by characteristics or metadata. For example, a user can be described to an LLM model as “likely to watch from 5 pm to 9 pm MST, prefers science fiction or drama, often watches comedy for last hour of session.” Currently playing data can include metadata that described the currently playing program. For example, currently playing data can include start time, expected end time, genre, actors, director, title, critical reception, tone, summary, or other descriptive data useable by the AI model to select for related content. The subject viewer or user and the content currently playing can be retrieved from database 114 including metadata describing users, their viewing habits, and content for use in prompting AI model 113.

System 100 can apply AI model 113 to viewer and content data to generate recommendation list (Block 208). The recommendation list can comprise recommendations based on the viewer data and the content data. AI model 113 can output the recommendations in response to inputs including the viewer data and content data, or the location at which the viewer data or content data can be retrieved. The recommendation list is described as a list of recommendations, but the list can also be empty (e.g., if no recommendations match the viewer and currently playing content), or can comprise a single recommendation in various embodiments. Recommendations can be output using a unique identifier for content. In some embodiments, the title of the content can be used as an identifier. In some embodiments, a primary can be used to identify content for recommendation. The identifier can be used to retrieve the recommended content in response to initiation of playback.

In some implementations, process 200 may be executed in real-time (or near real-time, recognizing some delays inherent in data processing, digital communications and the like). That is, automatically-generated viewing recommendations could be created in real time in response to a request from a trigger point in the current content, a request from the viewer, or the viewer browsing a content selection interface. This would permit highly customized viewing recommendations to be generated based upon the viewer's attributes, viewing history, and the like. Other embodiments could permit viewing recommendations to be generated prior to presentation, with the generated recommendations being stored (e.g., in database 114) until an appropriate time for presentation to the viewer. Still other embodiments could combine these approaches by permitting some viewing recommendations to be generated in advance, with additional recommendations generated in response to the viewer's real time behavior.

As noted above, program content 105 may be processed in any manner. In various embodiments, viewer device 140A identifies a program of interest via the content management system 124. The program could be a currently viewed program, for example, or a program in a playlist or the like. In still other embodiments, certain programs 105 may be selected for analysis even before the particular viewer selects the program to improve response times. Continuing the LLM-based example, the LLM can be trained on metadata describing the program content, viewers, and their viewing habits, and/or default viewing recommendations can be generated for storage and subsequent use in associated with the pre-processed program. In some embodiments, viewing histories can be stored and used for training and analysis.

Program metadata and viewer metadata can be analyzed in any manner to train AI model 113. Some implementations may analyze portions of the content itself (e.g., timed text, audio content via voice-to-text conversion, and/or video content via automated scene analysis) as described above. AI 113 may be trained based upon dialog and scene changes of the program, for example, to learn about the program content and to determine timing information so that the various scenes in the program can be referenced with regard to a viewer's playback point in the program, if desired. Additionally and/or alternatively, other information about program 105 may be used to train AI 113 so that further context or detail can be learned. Other information could include any sort of information from public or private databases, as noted above, as well as any external AI services that may be available, as desired.

“Metadata” about the program could include portions of the program itself (e.g., timed text) in addition to or as an alternative to other information about the media program that is available from other data sources 104. Training the AI could involve any process or technique by which the AI 113 becomes aware of the input data. As noted above, the AI may provide a framework or ingestion engine that receives input data that is then converted to mathematical vectors or the like for storage and subsequent processing. Data may be tagged, if desired, to permit more efficient recognition and conversion to digital format. Other embodiments may intake and analyze the received data in any other way.

In various embodiments, the viewing recommendations can be obtained from the AI 113 (and/or AI service 102) by placing a natural language query. RGE 110 or application 144 may include logic 115 for formatting natural language queries that can produce useful results from the trained AI 113. As noted above, queries may consider the viewer's demographic information, viewing history or preferences, previous acceptance or refusal of recommendations, or the like in generating specific queries to the AI 113. Formatted queries can be provided to any trained AI model to receive automatically-generated results. Queries can be placed to AI 113 or the like that has been trained on the specific program 105, for example, to obtain customized results.

Various embodiments may posit queries to both a local AI model 113 and to a network AI service 102 to obtain additional information, for redundancy, or for any other purpose. Queries may be simultaneously submitted, if desired, or queries could be staggered so that one service provides different information (e.g., “filling in the gaps”) in the information received from the other service. Again, functions could be shared or intermixed between local and remote AI engines 113 and 102 in any manner. For example, it may not be necessary to train AI 113 on every program 105. Some commercially available AI services 102 may already be trained on certain media programs 105 (e.g., more popular movies), for example, so those services could be queried as appropriate for information that is within their knowledge base, without the need to duplicate that knowledge locally. Still further embodiments could obtain a “first draft” of recommendation materials from an external AI service 102, with a locally-executing AI 113 providing more detailed context, as well as an added layer of viewer anonymity, if desired. Other hybrid scenarios could be formulated to use local or remote AI resources in any manner.

In various embodiments, system 100 may present a selected recommendation to viewer (Block 208). The recommendation may be selected by being returned from AI model 113 as a sole recommendation. The recommendation may be selected by ranking the list of recommendations based on relevance to the viewer and selecting the recommendation with the highest ranking. The recommendation may be selected from the list of recommendations using random selection or any other selection technique suitable for picking an element from a list.

The selected viewing recommendation may be presented to the viewer using viewer device 140A or a supplemental computing device in various embodiments. The recommendation can be overlayed on the currently playing content. For example, the recommendation can be selected and presented over current content in response to the credits rolling at the end of the content. The recommendation can be presented as a selectable button overlay that triggers playback in response to the viewer pressing the button. The recommendation can be presented as an autoplay icon with a countdown until playback is triggered automatically. The recommendation can be presented as a tile or other entry on a browsing page, a tile in an interface, or an interface ribbon, for example. For example, a user might have “Star Wars Episode 1” highlighted on a browsing interface and system 100 can recommend content in another tile or interface element. Similarly, recommendations can be presented in a browsing experience after a customer has viewed a program. The browsing tab can include a heading, “What to watch next”, “Ready for something different than ______?”, or other headings indicative of AI model recommending a different type of content.

Automatically-generated viewing recommendations can be provided to the viewer in any manner. If the recommendations are generated locally on the viewer device 140, for example, recommendations could be provided on a display via an interface as discussed above. If the recommendations are generated by RGE 110, the results could be provided to the viewer's device 140A and/or to a companion device also associated with the viewer via the content management system 124 and/or via API 112. In one example, API 112 provides a secure hypertext transport protocol (HTTP) interface that interacts with client application 144 to request and receive automatically-generated recommendations, although other embodiments could transfer the materials in other ways. Presentation typically results in playback or in a viewer declining the recommendation. In some embodiments, a recommendation being saved for later viewing may be categorized and logged as a success for future analysis to improve performance of RGE 110.

System 100 may check whether playback was initiated from the recommendation (Block 210). In response to playback being declined or otherwise uninitiated, an unsuccessful recommendation can be logged for future analysis (Block 212). AI 114 or AI service 102 can analyze past unsuccessful recommendations for the user in generating new viewing recommendations for the user. System 100 can thus avoid making the same unsuccessful recommendation repeatedly or too frequently for the same user.

In response to playback being initiated at viewing device 140A, system 100 may monitor playback of the recommended content for another recommendation trigger (Block 214). Since playback was initiated, the content is also logged in the user's viewing history for future analysis. Viewing history may include a flag indicating that playback resulted from a successful recommendation.

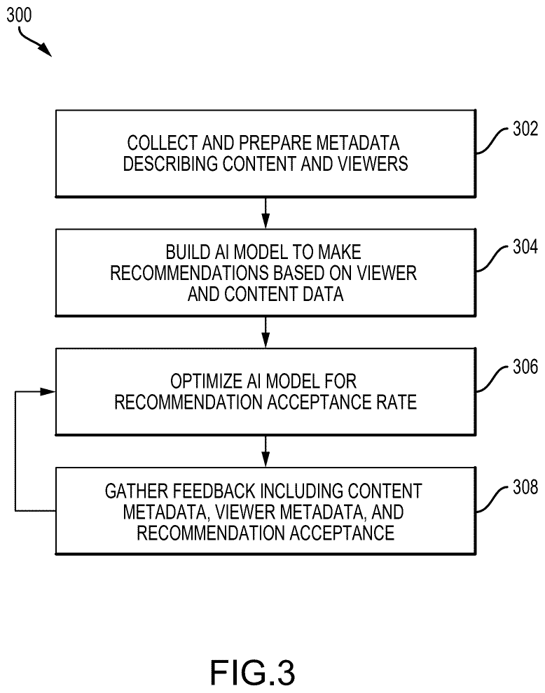

With reference to FIG. 3, an example process 300 is shown for training AI model 113, in accordance with various embodiments. Process 300 for training AI model 113 can include collecting and preparing metadata describing content and viewers (Block 302). Data collection can include collecting detailed information about users, such as their content ratings and reviews, viewing history, viewing habits, viewing session characteristics such as duration and content sequences, viewer demographics, or preferences. Data collection may also include metadata describing program content such as, for example, title, genres, cast, plot summaries, critical response, general reviews, characteristics, or other data related to content. After data collection, data may be cleaned by removing duplicates or malformed fields, handling missing values, normalizing entries to ensure consistency, or pruning likely bad data entries. Data can also be processed to create additional metadata fields such as, for example, weighting factors for various types of users or other second-level data.

Process 300 can also include training AI model 113 to make recommendations based on the metadata describing the viewers and the content (Block 304). Potential algorithms for AI model 113 can include collaborative filtering (both user-based and item-based), content-based filtering, matrix factorization techniques, or other learning methods. AI model 113 can be built by training it on the prepared dataset, which involves learning patterns and relationships from historical user characteristics and behavior as it relates to attributes of the viewed content.

Process 300 can include optimizing AI model 113 to achieve a high recommendation acceptance rate (Block 306). After training AI model 113, its performance may be evaluated using relevant metrics such as Mean Absolute Error (MAE), Root Mean Squared Error (RMSE), or precision and recall. Performance metrics can be used to assess how well the model predicts user preferences and the quality of its viewing recommendations. Based on the evaluation, AI model 113 can be revised by adjusting hyperparameters and improving features to enhance accuracy and relevance. In some embodiments, cross-validation techniques can help ensure that the model performs well on new data previously unseen by AI model 113.

Process 300 can also include gathering feedback including content metadata, viewer metadata, and recommendation acceptance (Block 308). The feedback can be collected as system 100 makes recommendations for the viewer and the currently playing content. Feedback can assist in understanding how well the recommendations are being received based on whether the recommended content is played back (or saved) or not. Feedback can be used to make iterative improvements, update the model with new data, and address poor performance. Feedback also enables system 100 to maintain effectiveness and relevance as time passes. System 100 can thus adapt to changing user preferences and trends as they are reflected in feedback data. Feedback can be used to refine or optimize AI model 113.

Benefits, other advantages, and solutions to problems have been described herein with regard to specific embodiments. Furthermore, the connecting lines shown in the various figures contained herein are intended to represent example functional relationships or couplings between the various elements. It should be noted that many alternative or additional functional relationships or connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used herein, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

The term “exemplary” is used herein to represent one example, instance, or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A process performed by a computer-based system comprising a processor, a non-transitory digital storage and an interface to a network, the process comprising:
receiving, by the computer-based system, first metadata descriptive of media programs watched by viewers and second metadata descriptive of the viewers;
providing the first metadata about the media programs and the second metadata about the viewers to train an artificial intelligence (AI) model on the viewers and the media programs;
detecting, by a viewer device playing a media program, a recommendation trigger during a first playback of the media program;
applying the AI model to third metadata related to the viewer and fourth metadata related to the media program during the first playback to generate a viewing recommendation for the viewer in response to the recommendation trigger; and
presenting the viewing recommendation to the viewer during the first playback of the media program on the viewer device.

2. The process of claim 1, wherein the AI model comprises a large language model (LLM).

3. The process of claim 2, wherein applying the AI model comprises:
formulating a natural language query including the third metadata and the fourth metadata; and
submitting the natural language query to the LLM to generate the viewing recommendation.

4. The process of claim 1, wherein presenting the viewing recommendation comprises displaying the viewing recommendation as an overlay on the viewer device during a second playback of a credit roll of the media program.

5. The process of claim 1, further comprising logging an unsuccessful recommendation in response to the viewer declining a second playback of the viewing recommendation.

6. The process of claim 1, further comprising monitoring a second playback of the viewing recommendation in response to the viewer accepting the second playback of the viewing recommendation.

7. The process of claim 1, wherein applying the AI model comprises:
applying the AI model to the third metadata and the fourth metadata to generate a list of viewing recommendations for the viewer, the list comprising the viewing recommendation; and
selecting the viewing recommendation from the list for presentation to the viewer.

8. The process of claim 7, wherein selecting the viewing recommendation from the list further comprises:
ranking the list of the viewing recommendations for the viewer; and
selecting the viewing recommendation from the list in response to a ranking of the viewing recommendation on the list.

9. A process for using an AI model running on a computer-based system comprising a processor, a non-transitory digital storage, and an interface to a network, the process comprising:
preparing first metadata describing program content and a second metadata describing viewers of the program content and associated behaviors;
training the AI model using the first metadata and the second metadata to make recommendations based on viewer data and content data;
receiving, by the AI model, third metadata related to a viewer and fourth metadata related to a current program during playback of the current program;
generating, by the AI model, a viewing recommendation for the viewer in response to the third metadata and the fourth metadata, wherein the viewing recommendation comprises a recommended genre different from a current genre of the current program;
returning, by the AI model, the viewing recommendation during the playback of the current program; and
receiving, by the AI model, a result of the viewing recommendation as feedback to refine the AI model.

10. The process of claim 9, further comprising optimizing the AI model using the feedback to improve a recommendation-acceptance rate.

11. The process of claim 9, wherein the third metadata includes a typical viewing period of the viewer, and wherein the AI model generates the viewing recommendation to have a runtime fit in the typical viewing period.

12. The process of claim 9, wherein the AI model generates the viewing recommendation with a recommended content that deviates from a preferred genre of the viewer based on similar past deviations of the viewer.

13. The process of claim 9, wherein the AI model generates the viewing recommendation with a recommended content that deviates from a preferred genre of the viewer based on similar past deviations of similar users.

14. The process of claim 1, wherein the AI model comprises a large language model (LLM).

15. The process of claim 2, wherein the AI model receives the third metadata and the fourth metadata in a natural language query.

16. The process of claim 1, further comprising monitoring a playback of content identified in the viewing recommendation in response to the viewer accepting the viewing recommendation.

17. A non-transitory computer-readable medium configured to store instructions thereon that, when executed by a processor, cause the processor to perform operations, the operations comprising:
receiving, by an AI model, first metadata related to a current viewer and second metadata related to a current program during playback of the current program on a viewer device;
generating, by the AI model, a viewing recommendation for the current viewer in response to the first metadata and the second metadata, wherein the viewing recommendation comprises a recommended genre different from a current genre of the current program;
returning, by the AI model, the viewing recommendation to the viewer device during the playback of the current program on the viewer device; and
receiving, by the AI model, a result of the viewing recommendation as feedback to refine the AI model.

18. The non-transitory computer-readable medium of claim 17, wherein the operations further comprise optimizing the AI model using the feedback to improve a recommendation-acceptance rate.

19. The non-transitory computer-readable medium of claim 17, wherein the first metadata includes a typical viewing period of the current viewer, and wherein the AI model generates the viewing recommendation to have a runtime fit in the typical viewing period.

20. The non-transitory computer-readable medium of claim 17, wherein the AI model generates the viewing recommendation with a recommended content that deviates from a preferred genre of the current viewer based on similar past deviations of the current viewer.
